(19) United States
(12) Patent Application Publication
(10) Pub. No.: US 2006/0261307 A1
(43) Pub. Date: Nov. 23, 2006

(54) Water Activated Organic Scavenger

(76) Inventors: D. Jeffrey Black, Akron, OH (US); Hussain Alghatta, Fiuggi (IT)

Correspondence Address: M&G USA, CORPORATION, 6951 RIDGE ROAD, SHARON CENTER, OH, 44274, US

(21) Appl. No.: 11/383,799

(22) Filed: May 17, 2006

Related U.S. Application Data
(60) Provisional application No. 60/682,247, filed on May 18, 2005.

(51) Int. Cl. C01B 3/00

(52) U.S. Cl. 252/188.28; 524/431

(57) ABSTRACT

Disclosed is a polyester composition of a polyester, an oxygen sensitive compound, such as a polyamide and a promoter which causes the oxygen sensitive compound to become reactive with oxygen and the promoter is strategically placed into the polyester or present at less than critical moisture activation ratio of the amount of oxygen sensitive compound to the amount of promoter, whereby there is more oxygen reactivity when the composition is wet, than when the composition is dry.

### PRIORITY AND CROSS REFERENCES

This patent application claims the benefit of the priority of U.S. Provisional Patent Application Ser. No. 60/682,247 filed May 18, 2005 the teachings of which are incorporated in their entirety.

### FIELD OF THE INVENTION

The invention relates to a polyester composition which can be made into a food or beverage container the wall of which will become reactive with oxygen when the container is filled. This invention allows food products to be stored longer in the container.

### BACKGROUND

As packaging demands become more complex, multiple components are needed to increase the functional properties of the package. Barrier to vapor or specific compounds such as oxygen is one of the more important of these properties. Oxygen barrier materials are expensive and it is therefore desirable to minimize their cost in the final package.

Barrier to oxygen can be achieved using passive or active barrier techniques. Passive barrier techniques reduce the transmission rate of the vapor or liquid into the package. By contrast, active barrier techniques incorporate material(s) into the wall of the package that react(s) with the vapor or liquid of concern and thus prevents their passage through the container wall.

The active barrier technique, as described in U.S. Pat. No. 5,021,515, involves the reaction of a component in the wall of the container with oxygen. Such a reaction has come to be known as oxygen scavenging. U.S. Pat. Nos. 5,021,515, 5,049,624, and 5,639,815, disclose packaging materials and processes which utilize a polymer composition which is capable of scavenging oxygen; such compositions include an oxidizable organic polymer component, preferably a polyamide (preferably m-xylylene adipamide or MXD6) and a metal oxidation promoter (such as a cobalt neodecanoate).

U.S. Pat. No. 5,529,833, describes a composition comprising an ethylenically unsaturated hydrocarbon oxygen scavenger catalyzed by a transition metal catalyst and a chloride, acetate, stearate, palmitate, 2-ethylhexanotae, neodecanoate or naphthenate counterion. Preferred metal salts are selected from cobalt (II) 2-ethylhexanoate and cobalt (II) neodecanoate.

U.S. Pat. Nos. 6,406,766, 6,558,762, 6,346,308, 6,365,247, and 6,083,585, teach to functionalize the oxidizable component such as a polybutadiene oligomer and react it into the backbone of the major polymer matrix, such as polyethylene terephthalate (PET). Such a composition may be incorporated into the wall of the container as a separate layer of the container wall or comprise the entire wall.

These organic systems are deficient because the container is active when made. That is, the container begins reacting with oxygen as soon as the catalyst is brought in contact with the organic compound. This immediate reactivity increases logistic costs as the container must be filled as soon as it is manufactured. At present, the only triggerable systems are based upon the oxidation of discrete metal particles.

The use of elemental or reduced metal scavengers is finding increased popularity in the walls of containers. Beneficially, these metals, usually in the presence of a promoter such as sodium chloride, are not reactive with oxygen until exposed to an external event which is moisture that triggers the reaction. In this case, a pellet or container wall containing a metal based scavenger will not react with oxygen unless placed in contact with moisture. In packaging applications, contact with moisture occurs when the container is filled and the moisture from the packaged foods permeates into the polymer matrix, thus initiating the reaction.

The use of an external agent to initiate the reaction makes this a triggerable system, whereas the previous organic systems are active when the container or pellet is made. While the discrete metal system is triggerable it has limited functionality relative to the organic system because the metal particles are not finely dispersed. When the metal particles are finely dispersed they create a dark color or haze which makes the container unacceptable in the market.

There therefore exists the need for a triggerable oxygen based scavenger system with the reactivity of the organic system.

### SUMMARY OF THE INVENTION

This invention relates to a molding composition which can be triggered to react with oxygen by exposing the composition to water. The composition is made by combining polyester, a polyamide and specific types of catalysts at set ratios and phase locations. This composition can then be cast into a sheet or film or molded into a container using techniques such as injection, injection blow, reheat blow, or extrusion blow. The material in the film or container will remain relatively unreactive to oxygen until exposed to moisture. The exposure to moisture happens when the material touches the packaged product which is usually aqueous. The moisture initiates or triggers the reaction of the composition with oxygen thus protecting the packaged ingredients from oxygen.

What is specifically disclosed is a composition comprising: a crystallizable aromatic polyester containing at least 85 mole percent of the acid units derived from terephthalic acid or the diester of terephthalic acid, an oxygen sensitive component, and a transition metal promoter, wherein the amount of oxygen scavenged by the composition after seven days at 50° C. when wet is less than the oxygen scavenged after seven days at 50° C. when dry. Further disclosed is that the oxygen sensitive component be a polyamide comprising the repeating unit of amino caproic acid or A-D, wherein A is the residue of a dicarboxylic acid comprising adipic acid, isophthalic acid, terephthalic acid, 1,4-cyclohexanedicarboxylic acid, resorcinol dicarboxylic acid, or naphthalenedicarboxylic acid, or a mixture thereof, and B is a residue of a diamine comprising m-xylylene diamine, p-xylylene diamine, hexamethylene diamine, ethylene diamine, or 1,4 cyclohexanedimethylamine, or a mixture thereof and the ratio of the amount of oxygen sensitive component to the amount of promoter is expressed as O/P where O is the amount of oxygen scavenging material in weight percent of the polymers in the composition and P is amount of the metal expressed in 100 ppm of the polymers in the composition, and O/P is less than the critical moisture activation ratio. It is also disclosed that the oxygen sensitive component be MXD6 nylon and the promoter be a cobalt salt. A water activatable oxygen scavenging resin composition is also disclosed that comprises a crystallizable aromatic polyester containing at least 85 mole percent of the acid units derived from terephthalic acid or the diester of terephthalic acid, an oxygen sensitive component, and a promoter, wherein the crystallizable aromatic polyester and oxygen sensitive components are present as separate phases and the promoter locations can be expressed as the equation OSP/OIP where OSP is the amount of promoter present in the oxygen sensitive phase, OIP is the amount of promoter present in the oxygen inert phase, wherein OSP/OIP is less than a critical ratio OSPc/OIPc where OSPc is the amount of promoter in the oxygen inert phase at the critical ratio, and OIPc is the amount of promoter in the oxygen inert phase at the critical ratio, where OSP+OIP equals OSPc +OIPc, and the critical ratio OSPc/OIPc is the ratio at which the rate of oxygen scavenging is three fourths the rate of oxygen scavenging when OSPc=OSPc+OIPc.

A water activatable oxygen scavenging resin composition comprising a crystallizable aromatic polyester containing at least 85 mole percent of the acid units derived from terephthalic acid or the diester of terephthalic acid, an oxygen sensitive component, and a promoter, wherein the crystallizable aromatic polyester and oxygen sensitive components are present as separate phases and the promoter is located substantially in the oxygen inert phase is also disclosed.

Also disclosed is the wall of a container made from any of the compositions.

### DESCRIPTION

The following embodiments demonstrate how to make the reaction with oxygen triggerable with water, something believed not to have been previously disclosed. The composition of the exemplary embodiments are a polyester, often polyethylene terephthalate and its crystallizable copolymers, a polyamide, often poly m-xylylene adipamide, also known commercially as MXD6, and a transition metal salt such as cobalt (II) or cobalt (III) acetylacetonate. Nylon 6 and Nylon 66 are polyamides also considered embodiments.

Suitable thermoplastic polymers for use in the present invention include any thermoplastic homopolymer or copolymer. Suitable thermoplastic polymers for use in the present invention include any thermoplastic homopolymer or copolymer. Examples of these include aliphatic, partially aromatic and aromatic polyamides, polyethylene terephthalate, polyethylene terephthalate copolymers, polybutylene terephthalate and its copolymers, polytrimethylene terephthalate and its copolymers, and polyethylene naphthalate and its copolymers, branched polyesters, polystyrenes, polycarbonate, polyvinyl chloride, polyvinylidene dichloride, polyacrylamide, polyacrylonitrile, polyvinyl acetate, polyacrylic acid, polyvinyl methyl ether, ethylene vinyl acetate copolymer, ethylene methyl acrylate copolymer, polyethylene, polypropylene, ethylene-propylene copolymers, poly(1-hexene), poly(4-methyl-1-pentene), poly(1-butene), poly(3-methyl-1-butene), poly(3-phenyl-1-propene) and poly(vinylcyclohexane). Some examples of oxygen inert thermoplastic polymers include polyethylene terephthalate, polyethylene terephthalate copolymers, polybutylene terephthalate and its copolymers, polytrimethylene terephthalate and its copolymers, and polyethylene naphthalate and its copolymers, branched polyesters, polystyrenes, polycarbonate, polyvinyl chloride, polyvinylidene dichloride, polyacrylamide, polyacrylonitrile, polyvinyl acetate, polyacrylic acid, polyvinyl methyl ether, ethylene vinyl acetate copolymer, ethylene methyl acrylate copolymer.

Typically the thermoplastic polymer used in the non-limiting embodiments comprises a polyester polymer or copolymer such as polyethylene terephthalate or a crystallizable copolymer of polyethylene terephthalate. The copolymer of polyethylene terephthalate is also expressed as a polyethylene terephthalate copolymer. For clarification the unmodified term PET refers to polyethylene terephthalate or polyethylene terephthalate copolymer. The term crystallizable refers to the ability of the polymer to be crystallized to some extent as measured by differential scanning calorimetry (D.S.C.). Typical crystallinity levels range from 5 to as high 65 percent depending upon the type of thermal treatment and nucleation techniques used. The term crystallizable is used to define the upper limit of comonomers. Beyond a certain level, the polyester will stay non-crystalline. While normatively this limit is 15 mole percent, the actual level will vary based upon the type of comonomers used.

It will be understood that the thermoplastic polymer suitable for use in the present invention can be extruded into a film, sheet, or other molded article such as a preform. If desired, the preform, film or sheet can then be stretched into a final container shape.

Polymers employed in the present invention can be prepared by virtually any polymerization procedure. The polyester polymers and copolymers may be prepared by melt phase polymerization involving the reaction of a diol with a dicarboxylic acid, or its corresponding diester. Various copolymers resulting from use of multiple diols and diacids may also be used. Polymers containing repeating units of only one chemical composition are homopolymers. Polymers with two or more chemically different repeat units in the same macromolecule are termed copolymers. For clarity, a polymer of terephthalate, isophthalate and naphthalate with ethylene glycol, diethylene glycol and cyclohexanedimethanol contains six distinct monomers and is considered a copolymer. The diversity of the repeat units depends on the number of different types of monomers present in the initial polymerization reaction. In the case of polyesters, copolymers include reacting one or more diols with a diacid or multiple diacids, and are sometimes also referred to as terpolymers. Additionally, randomization of the monomers is not necessary. A copolymer or terpolymer also refers to a polymer with different monomers be they in block or random distribution.

Suitable dicarboxylic acids include those comprising from about 6 to about 40 carbon atoms. Specific dicarboxylic acids include, but are not limited to, terephthalic acid, isophthalic acid, naphthalene 2,6-dicarboxylic acid, cyclohexanedicarboxylic acid, cyclohexanediacetic acid, diphenyl-4,4′-dicarboxylic acid, 1,3-phenylenedioxydiacetic acid, 1,2-phenylenedioxydiacetic acid, 1,4-phenylenedioxydiacetic acid, succinic acid, glutaric acid, adipic acid, azelaic acid, sebacic acid, and the like. Specific esters include, but are not limited to, phthalic esters and naphthalic diesters.

Also included are the monomers which create polyester ionomers such as metallo-sulfonates. Included in these are the sulfonated isophthalate salts of lithium, sulfur, and phosphorous.

These acids or esters may be reacted with an aliphatic diol, such as ethylene glycol, having from about 2 to about 10 carbon atoms, a cycloaliphatic diol having from about 7 to about 14 carbon atoms, an aromatic diol having from about 6 to about 15 carbon atoms, or a glycol ether having from 4 to 10 carbon atoms. Suitable diols include, but are not limited to, 1,4-butenediol, trimethylene glycol, 1,6-hexanediol, 1,4-cyclohexanedimethanol, diethylene glycol, resorcinol, and hydroquinone.

Polyfunctional comonomers can also be used, typically in amounts of from about 0.1 to about 3 mole percent. Suitable comonomers include, but are not limited to, trimellitic anhydride, trimethylopropane, pyromellitic dianhydride (PMDA), and pentaerythritol. Polyester-forming polyacids or polyols can also be used.

One non-limiting exemplary polyester is polyethylene terephthalate (PET homopolymer) formed from the approximate 1:1 stoichiometric reaction of terephthalic acid, or its ester, with ethylene glycol. Another preferred polyester is polyethylene naphthalate (PEN homopolymer) formed from the approximate 1:1 to 1:1.6 stoichiometric reaction of naphthalene dicarboxylic acid, or its ester, with ethylene glycol. Yet another preferred polyester is polybutylene terephthalate (PBT). PET copolymers, PEN copolymers, and PBT copolymers are also preferred. Specific co- and ter-polymers of interest are PET with combinations of isophthalic acid or its diester, 2,6 naphthalic acid or its diester, and/or cyclohexane dimethanol.

The esterification or polycondensation reaction of the carboxylic acid or ester with glycol typically takes place in the presence of a catalyst. Suitable catalysts include, but are not limited to, antimony oxide, antimony triacetate, antimony ethylene glycolate, organo-magnesium, tin oxide, titanium alkoxides, dibutyl tin dilaurate, and germanium oxide. Catalysts comprising antimony are preferred.

Another non-limiting exemplary polyester is polytrimethylene terephthalate (PTT). It can be prepared by, for example, reacting 1, 3-propanediol with at least one aromatic diacid or alkyl ester thereof. Preferred diacids and alkyl esters include terephthalic acid (TPA) or dimethyl terephthalate (DMT). Accordingly, the PTT preferably comprises at least about 80 mole percent of either TPA or DMT. Other diols which may be copolymerized in such a polyester include, for example, ethylene glycol, diethylene glycol, 1,4-cyclohexane dimethanol, and 1,4-butanediol. Aromatic and aliphatic acids which may be used simultaneously to make a copolymer include, for example, isophthalic acid and sebacic acid.

Useful catalysts for preparing PTT include titanium and zirconium compounds. Suitable catalytic titanium compounds include, but are not limited to, titanium alkylates and their derivatives, titanium complex salts, titanium complexes with hydroxycarboxylic acids, titanium dioxide-silicon dioxide-co-precipitates, and hydrated alkaline-containing titanium dioxide. Specific examples include tetra-(2-ethylhexyl)-titanate, tetrastearyl titanate, diisopropoxy-bis(acetyl-acetonato)-titanium, di-n-butoxy-bis(triethanolaminato)-titanium, tributylmonoacetyltitanate, triisopropyl monoacetyltitanate, tetrabenzoic acid titanate, alkali titanium oxalates and malonates, potassium hexafluorotitanate, and titanium complexes with tartaric acid, citric acid or lactic acid. Preferred catalytic titanium compounds are titanium tetrabutylate and titanium tetraisopropylate. The corresponding zirconium compounds may also be used.

Polymers of this invention may also contain small amounts of phosphorous compounds, such as phosphates, and a catalyst such as a cobalt compound, that tends to impart a blue hue. Other agents which may be included are infrared absorbers such as carbon black, graphite, and various iron compounds.

The melt phase polymerization described above may be followed by a crystallization step and then a solid phase polymerization (SSP) step to increase the molecular weight, as measured by Intrinsic Viscosity, necessary for bottle manufacture. The crystallization and polymerization can be performed in a tumbler dryer reaction in a batch-type system. Alternatively, the crystallization and polymerization can be accomplished in a continuous solid phase process whereby the polymer flows from one vessel to another after its predetermined thermal treatment in each vessel.

The crystallization conditions often include a temperature of from about 100° C. to about 150° C. The solid phase polymerization conditions usually include a temperature of from about 200° C. to about 235° C., and more often from about 215° C. to about 235° C. The solid phase polymerization may be carried out for a time sufficient to raise the molecular weight to the desired level, which will depend upon the application and initial intrinsic viscosity. For a typical bottle application, the preferred molecular weight corresponds to an intrinsic viscosity from about 0.68 to about 0.88 deciliter/gram, as determined by the methods described in the methods section. While common times required to reach this molecular weight may range from about 8 to about 45 hours, other times have been known to be used.

In one embodiment of the invention, the thermoplastic polymer matrix of the present invention may comprise recycled polyester or materials derived from recycled polyester, such as polyester monomers, catalysts, and oligomers.

For the purposes of this specification, the component that reacts with oxygen, such as the polyamide, is known as an oxygen reactive component or oxygen scavenger. The reaction of the component with oxygen is often promoted by an additional component that is also present in the wall of the package. A component that becomes reactive to oxygen when in the presence of a promoter is called an oxygen sensitive component. The promoter usually initiates and often catalyzes the reaction of the oxygen sensitive component with oxygen. After the oxygen sensitive component is exposed to the promoter and becomes reactive with oxygen, the oxygen sensitive component becomes an oxygen reactive component. When used in the claims to express the presence of the compound, the term oxygen sensitive component and oxygen reactive component will mean the same compound. The promoter may also be a combination of metal oxidation compounds and the word promoter therefore refers to the composition of materials used to catalyze and initiate the reaction of the oxygen sensitive component with oxygen, thus making it an oxygen reactive component.

The oxygen sensitive/ oxygen reactive compound can be one of many compounds. The oxygen reactive compound of this particular embodiment is an oxygen sensitive component that requires a reaction promoter to initiate or catalyze the reaction with oxygen. Active Food Packaging, M. L. Rooney ed., 1995 p 74-110 describes various types of oxidizable organic oxygen sensitive compounds. The oxygen sensitive compounds are generally ethylenically unsaturated organic compounds and may have an allylic hydrogen which is cleaved in the presence of oxygen and a promoter which is an initiator or catalyst. In this context a catalyst can be an initiator but an initiator is not always a catalyst. Generally, the reaction with oxygen is very slow or non-existent without the presence of the initiator or catalyst. An initiator is anything which starts the fast reaction of the compound with oxygen. A catalyst can both start the reaction and increase the rate of the reaction but does not participate in the reaction.

It should also be noted that polyamides, like polyolefins, become reactive with oxygen in the presence of a transition metal catalyst and are therefore also oxygen sensitive components. Thus, polyamides are also one of the non-limiting exemplary oxygen sensitive components. Specifically, the polyamides described in the previous embodiment are suitable oxygen sensitive components. Of those polyamides, the m-xylylene adipamide moiety is most common. Polybutadiene, polybutadiene oligomers and terpenes are other examples of oxygen sensitive materials that are promoted (initiated and/or catalyzed) by a transition metal catalyst.

Polyamides suitable for this invention can be described as comprising the repeating unit amino caproic acid or A-D, wherein A is the residue of a dicarboxylic acid comprising adipic acid, isophthalic acid, terephthalic acid, 1,4-cyclohexanedicarboxylic acid, resorcinol dicarboxylic acid, or naphthalenedicarboxylic acid, or a mixture thereof, and D is a residue of a diamine comprising m-xylylene diamine, p-xylylene diamine, hexamethylene diamine, ethylene diamine, or 1,4 cyclohexanedimethylamine, or a mixture thereof. These polyamides can range in number average molecular weight from 2000 to 60,000 as measured by end-group titration. These polyamides can also be described as the reaction product of amino caproic acid with itself and/or the reaction product of a residue of dicarboxylic acid comprising adipic acid, isophthalic acid, terephthalic acid, 1,4-cyclohexanedicarboxylic acid, resorcinol dicarboxylic acid, or naphthalenedicarboxylic acid, or a mixture thereof with a residue of a diamine comprising m-xylylene diamine, p-xylylene diamine, hexamethylene diamine, ethylene diamine, or 1,4 cyclohexanedimethylamine, or a mixture thereof.

Those skilled in the art will recognize many of the combinations as well known commercially available polyamides. The reaction product of the residues of sebacic acid with hexamethylene diamine is nylon 610 and the reaction product of the residues of adipic acid and hexamethylene diamine is nylon 66. Nylon 612 is another nylon which benefits from the invention. Nylon 6 is a special type of polyamide which is made by the opening of caprolactam and then polymerizing the resulting amino caproic acid which has a formula of H₂N—(CH₂)₅—COOH. The most useful polyamide is the reaction product of the residues of adipic acid and m-xylylene diamine, known as poly-m-xylylene adipamide. This product is commercially known as MXD6 or nylon MXD6 and can be purchased from Mitsubishi Gas Chemical Company, Japan.

Other examples of oxidizable organic compounds are listed in United States Patent 6,406,766, the teachings of which are incorporated herein by reference. Specific examples include polybutadiene, unhydrogenated polybutadiene oligomers, polypropylene oxide oligomers, and methyl pendant aromatic compounds. In addition to being physically blended with the major component, the oxygen sensitive moiety can be chemically functionalized in one or more areas and reacted with a material compatible with the major component. Usually, the best compatibility is obtained when the oxygen scavenging material is reacted with the major component itself. U.S. Pat. No. 6,406,766, describes how this can be accomplished. The functionalized oxygen scavenger can also be reacted with the same type of material as the major component. In other words, the best compatibility with polyethylene terephthalate is obtained when the functionalized oxygen scavenger is reacted with polyethylene terephthalate.

The promoter is an initiator or catalyst, or mixtures of initiators or catalyst and is any compound or combination of compounds that starts or accelerates the reaction of the oxygen sensitive component with oxygen. In the prior art, the initiator is usually a transition metal, most preferably a cobalt salt, such as cobalt neodecanoate and is not consumed by the reaction of the oxygen sensitive material with oxygen. Additionally, the oxygen sensitive component is sufficiently unreactive to oxygen unless the promoter is present in sufficient quantities and as has been discovered is in the phase of the oxygen sensitive component.

Therefore, one embodiment of this invention is to pre-compound the promoter and the oxygen inert component. For clarity, the phrase oxygen inert component refers to a component which does become reactive with oxygen when placed in contact with the promoter at the levels that make the oxygen sensitive component an oxygen reactive component. The oxygen inert component with the promoter could alternatively be combined the oxygen sensitive component in a compartmentalized resin pellet as described in WO 2005/110694 titled Compartmentalized Resin Pellets and published Nov. 24, 2005. The compartmentalized resin pellet keeps the promoter away from the oxygen sensitive component until the materials are homogeneously mixed in a melt extruder.

If the oxygen inert component, the promoter, and the oxygen sensitive component are not combined in the compartmentalized form, they can be homogeneously combined in the extruder and injection molded into a preform or the wall of the container. The system may exhibit low oxygen reactivity at this point, but the oxygen sensitive component is not completely reactive.

Once the container is made it is filled with water and the moisture will enter the wall of the container. In the case of polyester-polyamide, it is believed that the greater water absorption of the polyamide means that the water migrates through the PET phase to the polyamide. This migration transports the promoter from the polyester phase into the polyamide phase thus initiating or increasing the rate of the reaction of the oxygen sensitive component (polyamide) with oxygen. This is particularly the case when the transition metal is highly water soluble. The more useful transition metal compounds are those which are highly water soluble and prefer the polyester phase when the polyester and polyamide are combined in the liquid state.

One embodiment therefore comprises an oxygen inert component, for example polyethylene terephthalate and/or its copolymers, an oxygen sensitive component, for example polyamide, and a promoter, wherein the oxygen inert and oxygen sensitive components are present as separate phases. The promoter is desirably present only in the oxygen inert phase, however, one skilled in the art can readily determine that the promoter can be located between the two phases. It is therefore only a matter of experimentation to determine the fraction of the promoter that can be present in the oxygen sensitive phase and still maintain the increased oxygen reactivity after exposure to moisture. When the promoter is present in both phases, there will be a non-water activatable rate of scavenging which is the amount of oxygen consumed over a fixed period of time, usually 7 days, 50° C., and dry conditions (50% R.H.). The water activatable rate of scavenging is the amount of oxygen consumed over the same period time, at the same temperature, but with the composition in contact with aqueous solution (100% R.H.) as described later.

If the amount of promoter present in the oxygen inert phase is OIP and the amount of promoter present in the oxygen sensitive phase is OSP, then the amount between the phases can be expressed as OIP/OSP. The ratio will be higher when a greater amount of the promoter is in the oxygen inert phase than when in the oxygen sensitive phase. For a fixed amount of promoter, there exists a ratio of OIP/OSP where a sufficient percent of the promoter has been placed into the oxygen inert phase such that the rate of non-water activated scavenging is 75% of the rate of the non-water activated oxygen scavenging when OIP is 0. This ratio can be expressed as OIPc/OSPc where OIPc is the amount of promoter in the oxygen inert phase at this ratio, and OSPc is the amount of promoter in the oxygen sensitive phase at this ratio. The phrase the rate of non-water activated scavenging at OIPc/OSPc is 75% of the rate of the non-water activated oxygen scavenging when OIP is 0, compares the oxygen scavenging rate of the dry composition when the promoter is split between the two phases with the maximum dry oxygen scavenging rate which occurs when all the promoter is present in the oxygen sensitive component or OIP is 0.0.

Typically the total amount of promoter is not greater than 1000 ppm by the basis of metal relative to the amount of oxygen sensitive material. Levels greater than about 300 ppm do not show significant increases in dry oxygen reactivity. The above formula and relationship accounts for this relationship. Assume for instance that 100 ppm promoter in the oxygen sensitive phase had a rate 75% of that at 300 ppm in the oxygen sensitive phase, and there was no increase in activity above 300 ppm. If the total amount of promoter was 300 ppm, then the ratio OIPc/OISc would be 200/100 or 2.0. For a system with 500 ppm promoter, the ratio would be 400/100 or 4.0.

The promoter may optionally be a combination of transition metal compounds. In that case, the promoters are combined and treated as one promoter for the purposes of the formula. For example, cobalt chloride and cobalt neodecanoate are both highly active promoters. Because the equation treats the amount as based upon the amount of the metal, the contribution of weight or moles of other non-metallic component is ignored.

A exemplary embodiment of the above invention is the core-sheath compartmentalized pellet wherein the PET with the cobalt promoter is extruded into the sheath and the MXD6, other polyamide, or organic oxygen sensitive compound is extruded into the core. The pellet remains inert until exposed to water which drives the catalyst into the nylon and activates the reaction of the nylon with oxygen. Even after final melt extrusion and the components are combined into one article, the majority of the catalyst remains in the PET phase. While limited activation of the nylon may occur, once introduced to water, the nylon becomes much more active. The exact level of oxygen sensitive material and promoter can easily be determined by iterative techniques.

Another embodiment is based upon the discovery that high levels of cobalt relative to the amount nylon behave in the exact opposite manner as one would expect. It has been discovered that for a fixed amount of scavenger, the amount of scavenging that is initiated when the sample is kept dry (room conditions of 50% R.H. at 25° C.) decreases as the amount of catalyst increases and the amount of scavenging that is initiated when in contact with water increases as the catalyst amount increases. There exists then a critical ratio of moisture activation, referred to in the claims as the critical moisture activation ratio, which is the ratio of the amount of oxygen sensitive material to the amount of metal catalyst where the amount of scavenging under dry conditions equals the amount of scavenging under wet (100% R.H.) condition. This ratio is different for different temperatures and therefore 25 Deg C. is most appropriate room temperature. The critical moisture activation ratio for any system at 25 C is then the O/P where O is the amount of oxygen scavenging material in weight percent of the polymers in the composition and P is amount of the metal expressed in 100 ppm of the polymers in the composition.

Water activatable oxygen scavenging occurs when the ratio is less than 2.8, with less than 2.0 exhibiting better activation and less than 1.5 exhibiting better activation still. These compositions can be manufactured into the wall of a container, where the wall of a container is the portion of the package that is in contact with packaged contents. Cups, pouches, boxes, bottles, lids, preforms and wrapped films are also examples of such walls. Stretched and unstretched films are included in the definition of container walls.

As demonstrated in Table I of the experimental results, a PET and MXD6 system was blended with varying amounts of MXD6 and cobalt as cobalt acetylacetanoate. The amount of water activation decreased as the ratio of MXD6/Co+2 increased, either by raising the nylon or lowering the Co+2.

Experimental Results

The PET, MXD6 and Cobalt compounds were dry blended and then injection molded into preforms and blown into bottles. A sidewall was cut from the bottle and subjected to wet and dry conditions by placing the sidewall into a gas chromatograph bottle. The dry conditions are room humidity. The wet conditions are established by injecting 2 ml of 0.001 N HOAc into the vial to simulate juice or beer. The vial was sealed and placed in an oven operating at 50° C. and then the head space of the vial analyzed on the 7^{th} day for oxygen levels. The difference in oxygen between the head space and the amount in air is considered the amount of oxygen scavenged. That result is divided by the weight of the wall to account for any surface area or mass differences between the samples.

The wall was analyzed for the amount of nylon in the actual sample. This is done to account for imperfect mixing that may occur. The Co+2 amount is the amount of Co+2 added to the mixture expressed in ppm.

TABLE I
Wet and Dry Scavenging at 50° C.

| | | | | O/P | |
|---|---|---|---|---|---|
| MXD6 | Co + 2 | O2 Scavenging | | Ratio of MXD6 | Delta |
| Measured in | (ppm of | (cc O2/gm wall) | | to 100 ppm | Scavenging |
| Wall (wt %) | blend) | Wet | Dry | Co + 2 | (Wet − Dry) |
| 0.89 | 100 | 0.622 | 0.187 | 0.89 | 0.428 |
| 2.4 | 100 | 0.801 | 0.643 | 2.4 | 0.151 |
| 4.98 | 100 | 0.865 | 1.067 | 4.98 | −0.210 |
| 0.18 | 200 | 0.343 | 0.072 | 0.09 | 0.266 |
| 1.96 | 200 | 0.685 | 0.216 | 0.98 | 0.464 |
| 6.31 | 200 | 1.051 | 1.179 | 3.155 | −0.133 |
| 0.53 | 300 | 0.591 | 0.079 | 0.177 | 0.512 |
| 2.76 | 300 | 0.848 | 0.334 | 0.920 | 0.514 |
| 6.58 | 300 | 1.079 | 1.048 | 2.193 | 0.032 |
| 5.0 | 1000 | 0.338 | 0.057 | 0.5 | 0.281 |
| 5.0 | 1000 | 0.153 | 0.064 | N/A - | 0.089 |
| | (as | | | Co + 3 | |
| | Co + 3) | | | | |

It should be apparent that non-limiting embodiments are compositions comprising polyethylene terephthalate and/or its crystallizable copolymers with MXD6 and a cobalt based promoter, polyethylene terephthalate and/or its crystallizable copolymers with nylon 6 and a cobalt based promoter, polyethylene terephthalate and/or its crystallizable copolymers with nylon 66 and a cobalt based promoter, polyethylene terephthalate and/or its crystallizable copolymers with polybutadiene and a cobalt based promoter or polyethylene terephthalate and/or its crystallizable copolymers with functionalized polybutadiene and a cobalt based promoter.

Test Methods

The intrinsic viscosity of intermediate molecular weight and low crystalline poly(ethylene terephthalate) and related polymers which are soluble in 60/40 phenol/tetrachloroethane was determined by dissolving 0.1 grams of polymer or ground pellet into 25 ml of 60/40 phenol/tetrachloroethane solution and determining the viscosity of the solution at 30° C.±0.05 relative to the solvent at the same temperature using a Ubbelohde 1B viscometer. The intrinsic viscosity is calculated using the Billmeyer equation based upon the relative viscosity.

The intrinsic viscosity of high molecular weight or highly crystalline poly(ethylene terephthalate) and related polymers which are not soluble in phenol/tetrachloroethane was determined by dissolving 0.1 grams of polymer or ground pellet into 25 ml of 50/50 trifluoroacetic Acid/Dichloromethane and determining the viscosity of the solution at 30° C.±0.05 relative to the solvent at the same temperature using a Type OC Ubbelohde viscometer. The intrinsic viscosity is calculated using the Billmeyer equation and converted using a linear regression to obtain results which are consistent with those obtained using 60/40 phenol/tetrachloroethane solvent. The linear regression is
IV_{60/40 phenol/tetrachloroethane}=0.8229×IV_{50/50 trifluoroacetic Acid/Dichloromethane}+0.0124.

What is claimed is:

1. A polyester composition comprising: a crystallizable aromatic polyester containing at least 85 mole percent of the acid units derived from terephthalic acid or the diester of terephthalic acid, an oxygen sensitive component, and a transition metal promoter, wherein the amount of oxygen scavenged by the composition after seven days at 50° C. when wet is less than the oxygen scavenged after seven days at 50° C. when dry.

2. The composition of claim 1 wherein the oxygen sensitive component is a polyamide comprising the repeating unit of amino caproic acid or A-D, wherein A is the residue of a dicarboxylic acid comprising adipic acid, isophthalic acid, terephthalic acid, 1,4-cyclohexanedicarboxylic acid, resorcinol dicarboxylic acid, or naphthalenedicarboxylic acid, or a mixture thereof, and B is a residue of a diamine comprising m-xylylene diamine, p-xylylene diamine, hexamethylene diamine, ethylene diamine, or 1,4 cyclohexanedimethylamine, or a mixture thereof.

3. The composition of claim 2 wherein the ratio of the amount of oxygen sensitive component to the amount of promoter is expressed as O/P where O is the amount of oxygen scavenging material in weight percent of the polymers in the composition and P is amount of the metal expressed in 100 ppm of the polymers in the composition, and O/P is less than the critical moisture activation ratio.

4. The composition of claim 3 wherein the oxygen sensitive component is MXD6 nylon.

5. The composition of claim 3 wherein the promoter is a cobalt salt.

6. The composition of claim 3 wherein the ratio of the amount of polyamide to the amount of promoter is less than 2.8.

7. The composition of claim 3 wherein the ratio of the amount of polyamide to the amount of promoter is less than 2.0.

8. The composition of claim 3 wherein the ratio of the amount of polyamide to the amount of promoter is less than 1.5.

9. The wall of a container comprising the composition of claim 3.

10. A water activatable oxygen scavenging resin composition comprising a crystallizable aromatic polyester containing at least 85 mole percent of the acid units derived from terephthalic acid or the diester of terephthalic acid, an oxygen sensitive component, and a promoter, wherein the crystallizable aromatic polyester is present in an oxygen inert phase and oxygen sensitive component is present in an oxygen sensitive phase and the promoter locations can be expressed as the equation OSP/OIP where OSP is the amount of promoter present in the oxygen sensitive phase, OIP is the amount of promoter present in the oxygen inert phase, wherein OSP/OIP is less than a critical ratio OSPc/OIPc where OSPc is the amount of promoter in the oxygen inert phase at the critical ratio, and OIPc is the amount of promoter in the oxygen inert phase at the critical ratio, where OSP+OIP equals OSPc+OIPc, and the critical ratio OSPc/OIPc is the ratio at which the rate of oxygen scavenging is three fourths the rate of oxygen scavenging when OSPc=OSPc+OIPc.

11. The composition of claim 10 wherein the oxygen sensitive component comprises a polyamide; wherein the polyamide comprises the repeating unit of amino caproic acid or A-D, wherein A is the residue of a dicarboxylic acid comprising adipic acid, isophthalic acid, terephthalic acid, 1,4-cyclohexanedicarboxylic acid, resorcinol dicarboxylic acid, or naphthalenedicarboxylic acid, or a mixture thereof, and B is a residue of a diamine comprising m-xylylene diamine, p-xylylene diamine, hexamethylene diamine, ethylene diamine, or 1,4 cyclohexanedimethylamine, or a mixture thereof.

12. The composition of claim 11 wherein the polyamide is MXD6 nylon.

13. The composition of claim 11 wherein the promoter is a cobalt salt.

14. The wall of container comprising the composition of claim 11.

15. A water activatable oxygen scavenging resin composition comprising a crystallizable aromatic polyester containing at least 85 mole percent of the acid units derived from terephthalic acid or the diester of terephthalic acid, an oxygen sensitive component, and a promoter, wherein the crystallizable aromatic polyester is present in an oxygen inert phase and oxygen sensitive component is present in an oxygen sensitive phase and the promoter is located substantially in the oxygen inert phase.

16. The composition of claim 15 wherein the oxygen sensitive component comprises a polyamide containing the repeating unit of amino caproic acid or A-D, wherein A is the residue of a dicarboxylic acid comprising adipic acid, isophthalic acid, terephthalic acid, 1,4-cyclohexanedicarboxylic acid, resorcinol dicarboxylic acid, or naphthalenedicarboxylic acid, or a mixture thereof, and B is a residue of a diamine comprising m-xylylene diamine, p-xylylene diamine, hexamethylene diamine, ethylene diamine, or 1,4 cyclohexanedimethylamine, or a mixture thereof.

17. The composition of claim 16 wherein the polyamide is MXD6 nylon.

18. The composition of claim 16 wherein the promoter is a cobalt salt.

19. The wall of a container comprising the composition of claim 16.

20. The wall of a container comprising the composition of claim 1.
